(19) United States
(12) Patent Application Publication
(10) Pub. No.: US 2014/0049006 A1
(43) Pub. Date: Feb. 20, 2014

(54) Bankers' Playing Card Game

(71) Applicant: Patrick Thomas McGrath, Luton (GB)

(72) Inventor: Patrick Thomas McGrath, Luton (GB)

(21) Appl. No.: 13/965,801

(22) Filed: Aug. 13, 2013

Related U.S. Application Data
(60) Provisional application No. 61/683,236, filed on Aug. 15, 2012.

(51) Int. Cl. G07F 17/32; A63F 1/00

(52) U.S. Cl. CPC G07F 17/3293; A63F 1/00
USPC 273/292

(57) ABSTRACT

A banker's card game in which: a player plays two double denomination playing cards from a deck of mutually different cards, and the player has a first hand value that is the sum of a) the designated value of the first playing field of the first card and the designated value of the first playing field of the second card and has a second hand value comprised of the sum of a) the designated value of the second playing field of the first card and b) the designated value of the second playing field of the second card; and a banker plays a third double denomination playing card and a fourth double denomination playing card from the deck under the same rules; and the player's first hand value is played/compared against the banker's initial hand value and the player's second hand value is played/compared against the banker's further hand value.

### FIELD OF THE INVENTION

The present invention concerns a bankers' card game played with a set of playing cards. The present invention may be played on any platform, including for example in land based and online casinos, in apps, in social networks and in mobile devices.

### BACKGROUND TO THE INVENTION

A bankers' game is defined as a game of unequal chance, where the banker/dealer retains an edge as is present in games like Roulette, Blackjack and Baccarat and others. The present invention is a banker's game that is a card game and in which the cards played in the game are double denomination playing cards.

Double denomination playing cards are playing cards that are divided into a first playing field and a second playing field where each of the first playing field and a second playing field has a respective designated value. The double denomination playing cards are suitably as described and illustrated in detail in the present applicant's own earlier US patent application (U.S. Ser. No. 13/212,023) published as US 20120043721. The entire contents of US patent application US 20120043721 are by reference incorporated herein. The deck of cards for the game of the present invention is a deck of double denomination playing cards, there preferably being at least 1,378 cards in the deck, each card being unique so that the deck provides every possible combination of a standard 52 card deck. A subset of a 1,378 card deck configured to maintain symmetry may also be used.

The double denomination playing cards each suitably have a front playing face, where each playing face is divided into a first playing field and a second playing field whereby in a 1,378 cards deck the deck has a total of at least 1,378 first playing fields and at least 1,378 second playing fields, no two cards being the same. Each playing field suitably contains one of four non-denominational suits selected from the group comprising: Hearts; Clubs; Diamonds; and Spades, with each playing field further containing one of thirteen value designations selected from the group comprising: 2; 3; 4; 5; 6; 7; 8; 9; 10; Jack; Queen, King; and Ace, whereby each playing field contains a said non-denominational suit and a said value designation.

In one preferred embodiment the deck is computer-generated and each card that is played is displayed on a display screen.

Each playing card may have a back face that has identical indicia to the front playing face of that card, but preferably the back face is blank or lacks playing fields.

Each playing card is suitably elongate rectangular in shape, the front playing face of the card having a top part and a bottom part, wherein the first playing field is at the top part and the second playing field is at the bottom part. Preferably the first playing field is divided from the second playing field by a dividing line.

The double denomination playing card has two denominations on each playing card. To encompass the randomness and every possible combination of a standard 52 card deck in a double denomination card deck results in a deck of playing cards numbering 1378 cards. Each card front playing face is divided to have both a first and a second (e.g. a ‘top’ and a ‘bottom’) playing field whilst retaining the randomness of a standard 52 deck of playing cards throughout the 1378 card deck or subsections of the 1378 card deck.

In the deck the first and a second (e.g. ‘top’ and ‘bottom’) playing field of any of the double denomination cards are separate entities in their own right. Their value and operation is restricted to interaction with other double denomination cards along the top and bottom playing field to ensure that the cards can be rotated at all times.

A sub-deck may be formed from a 1378 card deck by removal of one or more cards whereby the sub-deck contains the symmetric function of the deck whereby there is a complete symmetry within the sub-deck; every card, suit and value being on an equal footing. As an example of such a sub-deck, this might be one that totals 240 double denomination cards. In compiling the 240 card sub-deck an intermediate deck may first be formed comprising: ace; 2; 3; 4; 5; and 6, with 4 suits making a total of 300 cards when all combine with each other. Of these 300 cards, 24 are cards containing two objects of equal value of the same suit, ie ace of hearts and ace of hearts, these are removed as are 36 where the top and bottom object has the same value but is of a different suit, ie ace of hearts and the ace of spades; leaving 240 cards. This sub deck contains the symmetric function of the full deck in that there is a complete symmetry within the deck, every card, suit and value is on an equal footing. Within this 240 card deck there are 15 cards all hearts, 15 cards all spades, 15 cards all diamonds and 15 cards all clubs totalling 60 cards, as well as 30 of mixed suit all red and 30 mixed suit cards all black, again totalling 60. The remaining 120 cards are mixed suit and mixed colour. This deck, along with the full deck permit a function that is absent from the prior art. Without exception the known prior art before US 20120043721 uses double denomination cards simply for extra values to strengthen a single hand. By contrast the double denomination deck of US 20120043721 is configured to have the ability to run parallel games on top and bottom fields and can be reduced to sub-decks with symmetry that also run parallel games on top and bottom fields.

It is an object of the present invention to provide a bankers' playing card game that introduces new game mechanics, game play and betting options that are not previously available in the prior art.

### SUMMARY OF THE INVENTION

According to a first aspect of the present invention there is provided a banker's card game in which:

i) a player plays a first double denomination playing card and a second double denomination playing card from a deck of mutually different cards, with each double denomination playing card having thereon a first playing field with a designated value and a second playing field with a designated value that is independent of the designated value of the first playing field, and the player has a first hand value that is the sum of a) the designated value of the first playing field of the first card and the designated value of the first playing field of the second card and has a second hand value comprised of the sum of a) the designated value of the second playing field of the first card and b) the designated value of the second playing field of the second card;
ii) a banker plays a third double denomination playing card and a fourth double denomination playing card from said deck of mutually different cards, with each double denomination playing card having thereon a first playing field with a designated value and a second playing field with a designated value that is independent of the designated value of the first playing field, and the banker has a third hand value that is the sum of a) the designated value of the first playing field of the third card and b) the designated value of the first playing field of the fourth card and has a fourth hand value that is the sum of a) the designated value of the second playing field of the third card and b) the designated value of the second playing field of the fourth card; and
iii) the player's first hand value is played/compared against the banker's third hand value and the player's second hand value is played/compared against the banker's fourth hand value.

In the game the player is thus playing two double denomination playing cards against the banker's two double denomination playing cards.

The first playing field of a playing card is preferably in an upper half or ‘top end’ of the front face of the playing card and the second playing field is preferably in a lower half or ‘bottom end’ of the front face of the playing card. In the game the player's cards while lying flat on one face can be spun to be upside down by the player to dictate which half is the top end and which half the bottom end.

Particularly preferably the playing cards in a player's hand are placed side by side and the denominated values of the playing cards from the player's first hand are read in a row (horizontally) and summed together.

Preferably the double denomination playing cards are all drawn from a set or deck that comprises at least 240 mutually different (no two cards the same) double denomination playing cards and particularly preferably they are a symmetrical sub-deck of a deck of 1,378 mutually different double denomination playing cards.

### BRIEF DESCRIPTION OF THE DRAWINGS

Preferred embodiments of the present invention will now be more particularly described, by way of example only, with reference to the accompanying drawings, wherein like reference numbers designate the same or similar parts throughout the several views, and wherein:

FIG. 1 is an image of every card present in a 240 card deck.

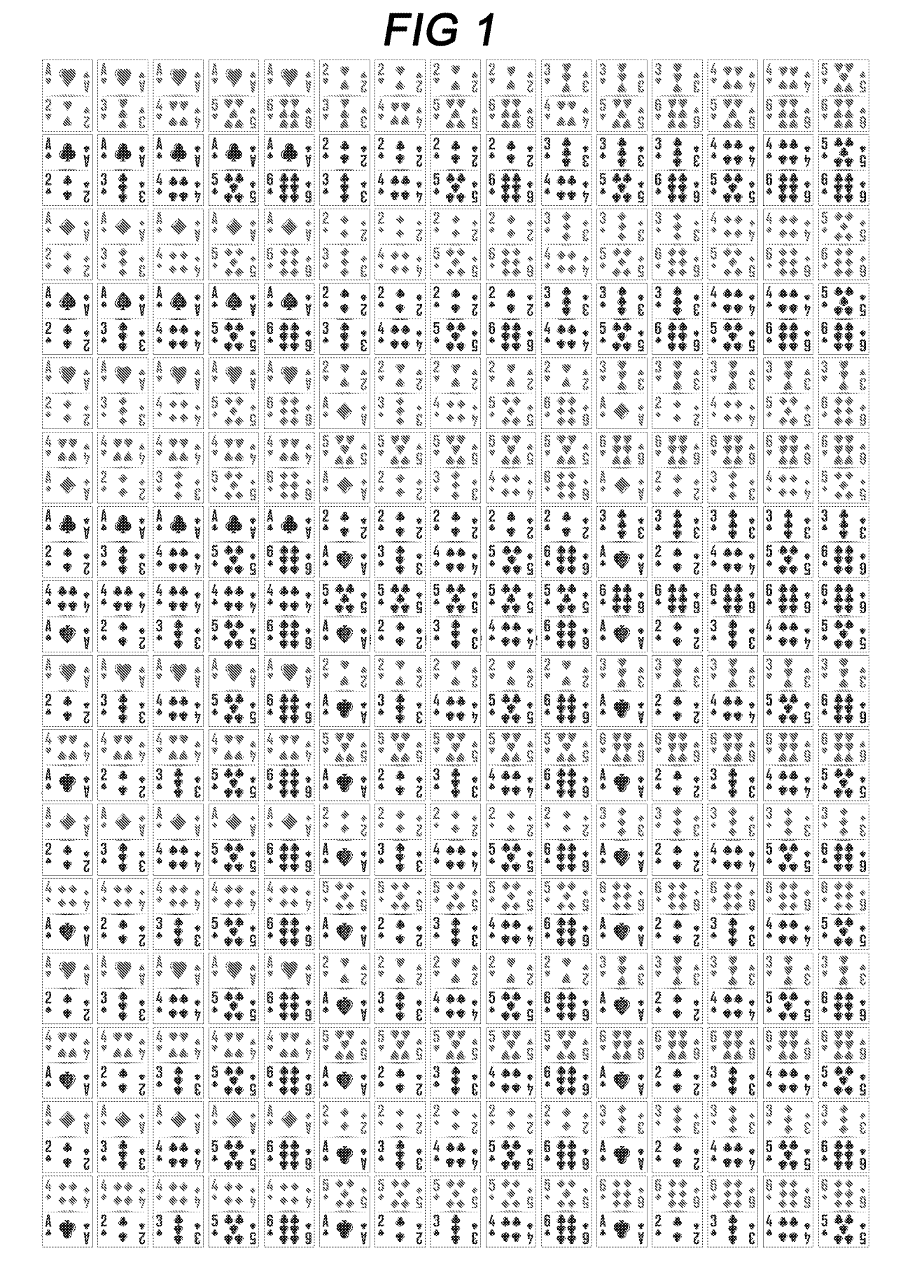

FIG. 2 is a top down view of a physical layout played on a kidney shaped or Blackjack style table for use in land based casino.

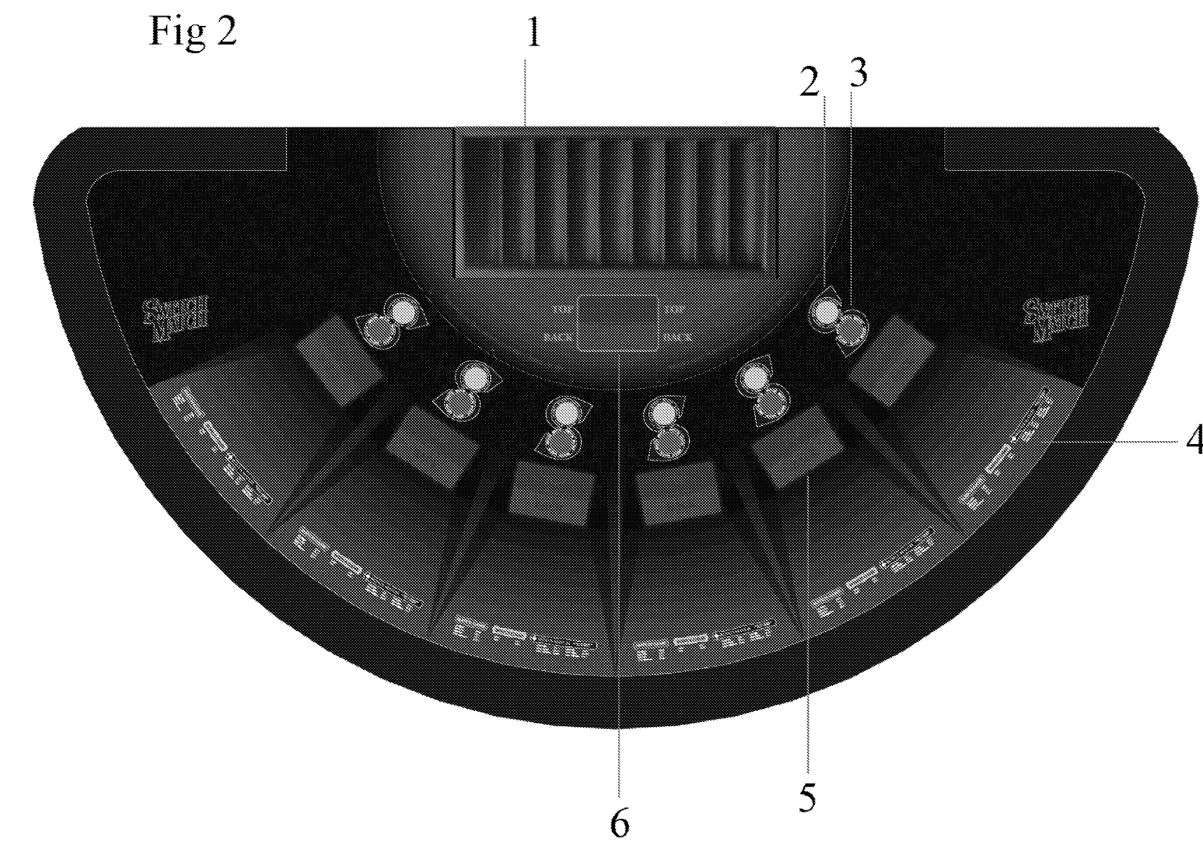

FIG. 3 is an example of the invention on a display used for play such as a computer screen or for remote online versions on handheld or mobile devices.

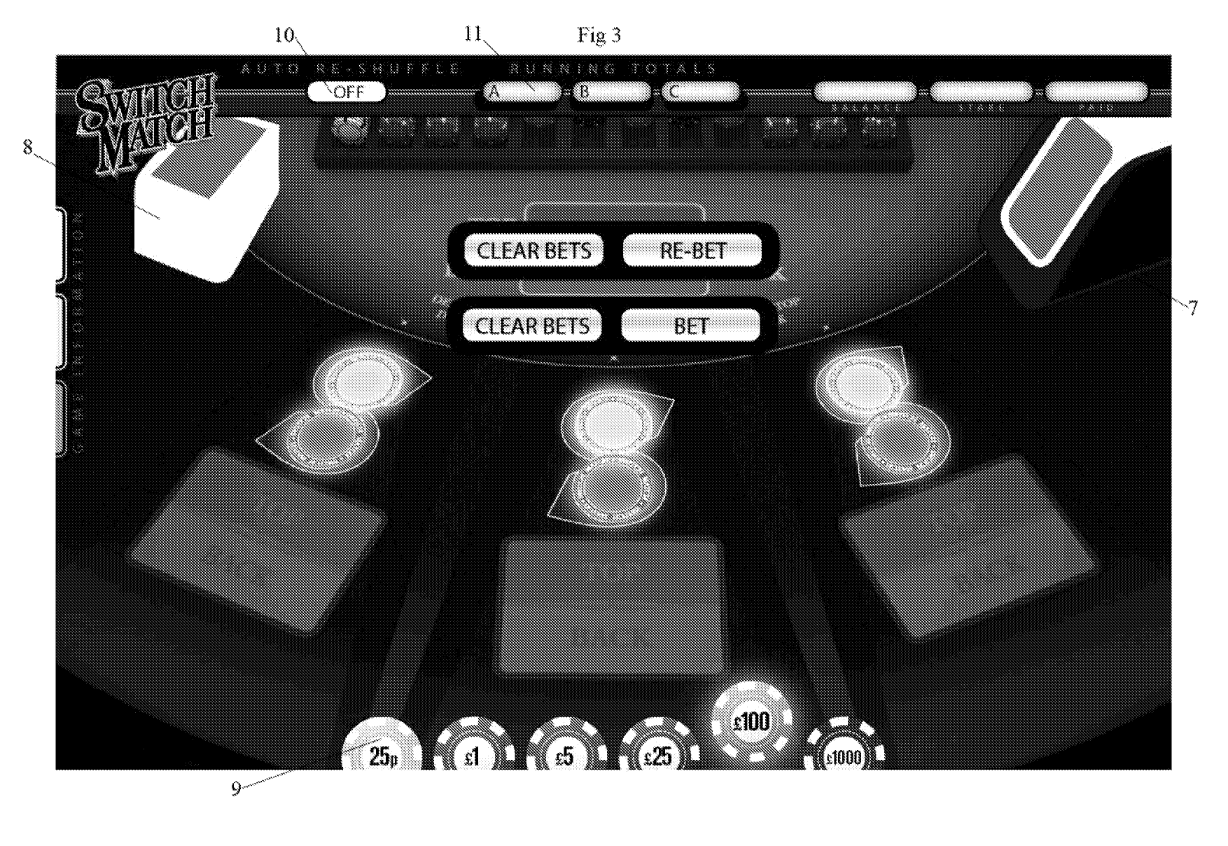

FIG. 4 is an extension of FIG. 3 which displays three player hands plus the dealer's hand with the cards face down.

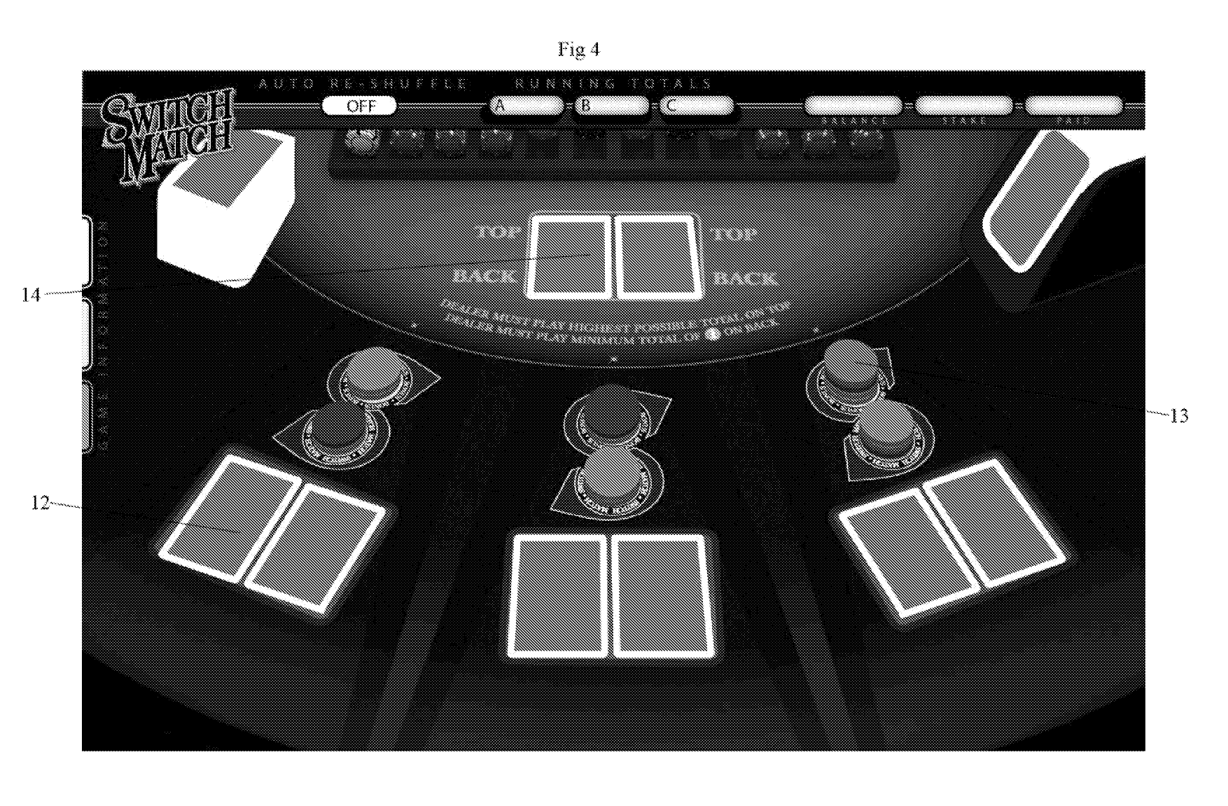

FIG. 5 is an illustration of the invention on a display showing an example user interface for rotating the player's cards prior to declaring their hand.

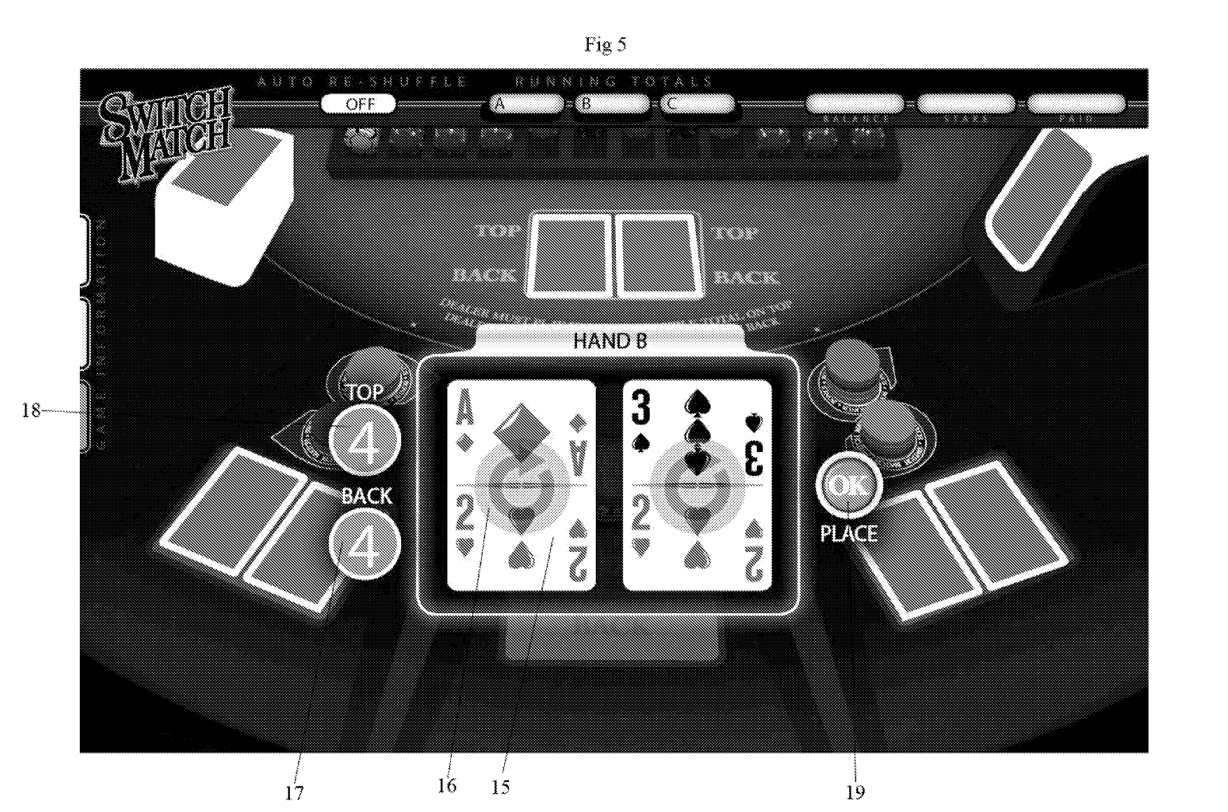

FIG. 6 is an example of the invention on a display showing an illustration user interface where the player has declared their hand.

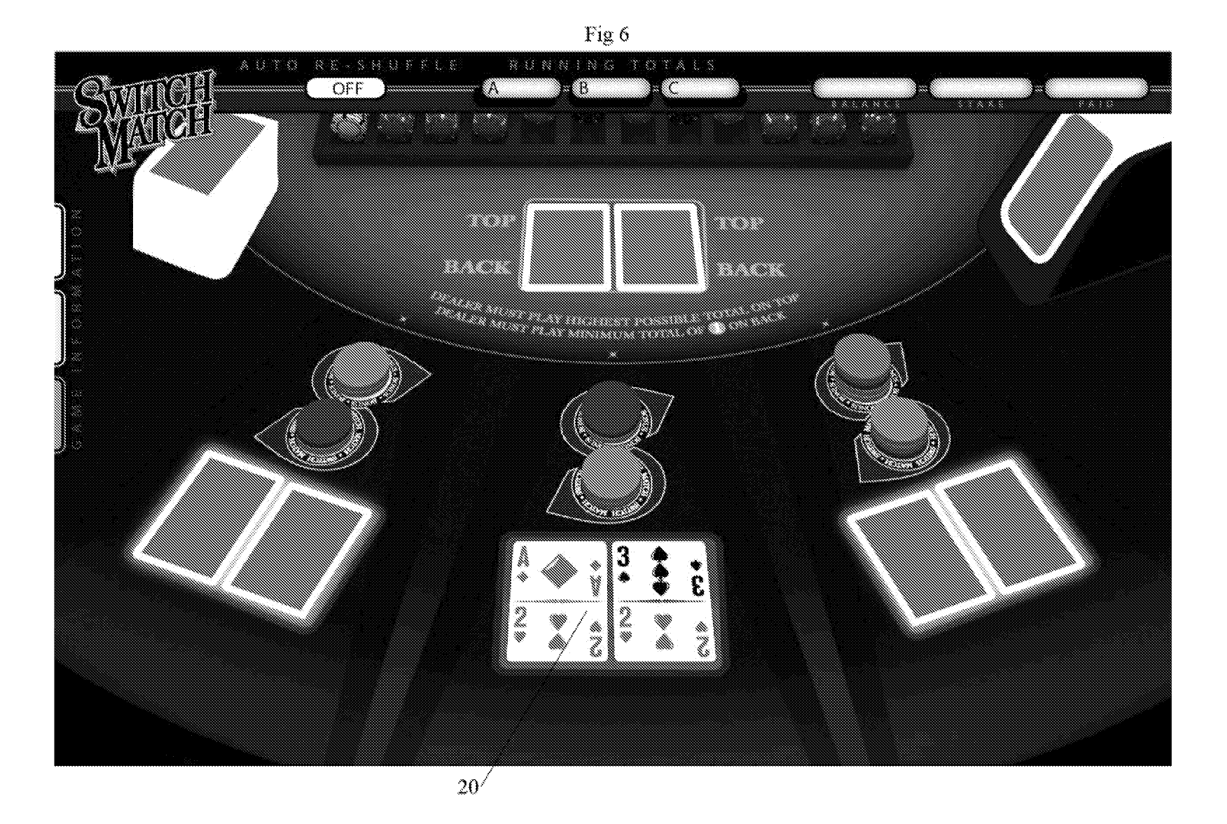

### KEY TO REFERENCE NUMBERS USED IN THE DRAWINGS

1. Chip tray
2. Bonus betting areas
3. Mandatory Betting area
4. Layout pay table
5. Player's card placing area
6. Dealer's card placing area
7. Digital card shoe
8. Digital Discard
9. Digital chips value selector
10. Digital shuffle option
11. Digital Total's display
12. Digital Player's Card (face down)
13. Digital chip
14. Digital Dealer's Card (face down)
15. Digital Card in close perspective
16. Digital card switch selector
17. Digital Back hand value
18. Digital Top Hand value
19. Digital hand declare button
20. Digital Player's hand revealed

### DETAILED DESCRIPTION OF THE PREFERRED EMBODIMENTS

### Main Elements

The game is a two card game played against the dealer. The dealer is also referred to herein as the ‘banker’ and may be a person or, in the case of a computer-implemented card game may be a subroutine/computer program.

The game uses a special set of double-ended playing cards, not dissimilar to a set of dominos. Each playing card has a front playing face, where the front playing face is divided into a first playing field at the upper end of the card and a second playing field at the lower end of the card. Each playing field suitably contains one of the four non-denominational suits selected from the group comprising: Hearts; Clubs; Diamonds; and Spades, with each playing field further containing one of the thirteen value designations selected from the group comprising: 2; 3; 4; 5; 6; 7; 8; 9; 10; Jack; Queen, King; and Ace, whereby each playing field contains a said non-denominational suit and a said value designation.

Due to the double-ended nature of the cards the player plays both a top hand and a back (bottom) hand at the same time. The lowest value card has a value of one (Ace) the highest value is six.

The 240 deck is a sub-set of a 1,378 cards deck and contains the symmetric function of a standard 52 card deck in that there is a complete symmetry within the deck, every card, suit and value is all on an equal footing. Within this 240 card deck there are 15 cards all hearts, 15 cards all spades, 15 cards all diamonds and 15 cards all clubs totalling 60 cards, as well as 30 cards of mixed suit, which are all red and 30 cards of mixed suit cards all black, again totalling 60. The remaining 120 cards are mixed suit and mixed colour.

The game uses the modulus 10 (or Mod 10) form of arithmetic when adding up the total of the “Top” and “Back” hand. For example, if a player arranges his/her cards so a “5” and a “6” are added together, the total is 1 rather than 11 as the numbers “wrap around” when ten is achieved. So a 5 and a 5 equals zero, a 4 and a 6 equals zero, a 5 and a 6 equals 1, a 6 and a 6 equals 2. Any other value added together will total 9 or lower. The highest total achievable in the game is 9.

The primary aim of the game is to match the player totals with that of the dealer to receive a pay-out. The game is run over two stages with two further sub stages played in particular circumstances.

### Sub Elements

A preferred rules embodiment is set out below, although this is just one example of various embodiments possible within the 240 card deck.

The game is played by an individual against the dealer. The game offers a mandatory bet and an optional bet. The mandatory bet in the game is referred to as the ‘Match bet’ and must be placed to commence the game. The optional bet in the game is referred to as the Bonus bet and must be placed prior to the cards being dealt. The Bonus bet cannot be played in isolation. The Bonus bet must be lower or equal in value to the Match Bet. Additional side bets can be added, for example, a betting area can be included for betting on the dealer's hand containing a novelty hand.

### Stage 1

Having placed the minimum bet required, the player receives two cards face down and the dealer receives two cards face down. The player picks up his/hers cards and arranges their cards so that two of the numbers added together horizontally form the “Top” hand and two of the numbers added together form the “Back” hand in a manner of the player's choosing. The player places their cards face up in the designated area thereby declaring their selection. Once the player has declared their selection they are not permitted to return to their cards.

### Stage 1a

Prior to the dealer revealing his/her hand the dealer will check to see whether any of the player's hand qualify for a bonus pay-out providing a stake has been placed on the relevant betting area. If no bonus hand is present the game moves to Stage 2 To qualify for a bonus, the player's hand (both cards) must contain the following novelty/s.

### A Straight

If the numbers shown on the player's cards form a straight (a sequence of four numbers), i.e. Ace, 2, 3, 4 or 2, 3, 4, 5 or 3, 4, 5, 6 and the cards are not all the same colour then the player wins and is paid according to a pay table

### 2 Pair

If the numbers shown on the player's cards form two pairs (e.g. one card 2 of diamonds and 6 of hearts and the other card 2 of spades and 6 of hearts) and are not all the same colour then player wins and is paid according to a pay table.

### Colour Straight

If the numbers on the player's cards form a straight (see above) and they are all the same colour (but not a flush) then the player wins and is paid according to a pay table.

### 2 Pair Colour

If the numbers shown on the player's cards form two pairs (e.g. one card 2 of diamonds and 6 of hearts and the other card 2 of hearts and 6 of hearts) and are all the same colour then player wins and is paid according to a pay table.

### Flush

If the suits shown on the player's cards are all the same (a flush) but the numbers do not form a straight (see above) then the player wins and is paid according to a pay table.

### Straight Flush

If the numbers on the player's cards form a straight (see above) and they are also a flush (see above) then the player wins and is paid according to a pay table.

The preferred set of rules outlined herein is just one example of various embodiments possible within the spirit and scope of the present invention and the following is one preferred example of pay table. Variations on any particular pay table are numerous, with the following pay table preferred,

Pay Table 1

| | |
|---|---|
| Straight: | 3 to 1 |
| 2 Pair: | 6 to 1 |
| Colour Straight: | 3 to 1* |
| 2 Pair Colour: | 6 to 1* |
| Flush: | 10 to 1* |
| Straight Flush: | 36 to 1* |

*(Qualifies for Bonus Match)

The invention contains a novel betting mechanic not available in any of the prior art for bankers' games; the Bonus Match as described below.

Many bankers' games contain a side bet/bonus that generally offers specific novelties so as to offer players additional betting options for configurations of hands that appear periodically during the main function of the said game. For example, 3 card Poker, contains a bet (pair plus) where players can wager an additional bet on their hand containing a novelty. In 3 card poker, players can achieve additional payouts if their hand contains a pair, (two cards of the same value), a flush (three cards of the same suit), a straight, (a sequence of three numbers, eg. 3, 4 and 5) Three of a kind (3 cards of the same value) and a straight flush (a sequence of numbers, e.g. 6, 7 and 8 of the same suit). The Bonus Match feature in the present invention expands this side bet/bonus feature to permit players to increase their winnings still further by risking their winning payout by betting against the dealer's hand.

If a player achieves either a Colour Straight, 2 Pair Colour, Flush or Straight Flush, the relevant player/s are then asked by the dealer individually “Would you like to

Bonus Match with the dealer?” If the player declines to Bonus Match the dealer's hand they receive a pay-out according to the pay table and their bonus stake is returned.

### Bonus Match

There are two elements required to receive an additional bonus pay-out. Firstly, the player must have received a bonus style hand, either a Colour Straight, 2 Pair Colour, Flush or Straight Flush. Secondly, when asked whether they wish to Bonus Match, if they answer in the affirmative then three possible outcomes can occur.

Below is a suggested pay table for the Bonus Match Game:

Pay Table 2

| Player/s | Dealer | Colour | Outcome | Designation |
|---|---|---|---|---|
| Bonus Hand | (red) | Mixed Colour | Push | No Match |
| Bonus Hand | (red) | Colour Red | 3 to 2 | Match |
| Bonus Hand | (red) | Colour Black | Lose | Mismatch |
| Bonus Hand | (black) | Mixed Colour | Push | No Match |
| Bonus Hand | (black) | Colour Red | Lose | Match |
| Bonus Hand | (black) | Colour Black | 3 to 2 | Mismatch |

Once the player/s has confirmed their wish to Bonus Match the banker/dealer turns one of his/her/its cards over. If the turned card is of mixed colour the dealer cannot make a bonus hand and immediately returns the relevant players winnings and stake to the player/s. If the turned card is the same colour, the dealer then reveals the second card. If the second card is of mixed colour the dealer immediately returns the relevant players winnings and stake to the player/s.

If both the dealer's cards are the same colour or the same suit the dealer has achieved a bonus hand and a comparison with the relevant player/s hand takes place with a pay-out or reduction according to the above pay table.

All bonus winnings and stakes are returned to the relevant player/s before the final stage of the game can begin.

### Stage 2—Match

This stage deals with the player/s hand in comparison to the dealer's hand based on their numerical value. The player/s can arrange their hand in four possible configurations as they attempt to match one or more of their totals with the dealer to receive a pay-out.

The dealer's hand is subject to the following rule/s
“Dealer Must Play Highest Possible Sum on Top” and
“Dealer must Play Minimum total of One on Back”.

This means the dealer only has one possible configuration that can be played. So for example, if the dealer can make the total “9” on the top hand he must arrange his cards to ensure this total is made providing his back hand totals at least “1”. In other words, the dealer cannot have Zero as a back hand; it must total at least “1” or more. Once all players have declared their selection the dealer would turn one of his/her cards over face up placing it in the dealer's designated area, then turn the remaining card over face up. At this point the dealer must arrange the cards in the designated area to observe the dealer rule/s.

With the dealers hand configured, each player's hand is then compared against the dealer's hand with the following preferred pay-outs awarded.

### Any Match

If the sum of the “top” hand match and the sum of the player's “back” hand is smaller than that for the dealer then the player wins and is paid at odds of evens.

### Match Plus

If the sum of the “top” hand match and the sum of the player's “back” hand is larger than that for the dealer then the player wins and is paid at odds of 3 to 2.

### Any Match

If the sum of the player's “top” hand is smaller than that of the dealer and the sum of the player's “back” hand matches that of the dealer then the player wins and is paid at odds of evens (ie 1 to 1).

### Match Plus

If the sum of the player's “top” hand is larger than that of the dealer and the sum of the player's “back” hand matches that of the dealer then the player wins and is paid at odds of 3 to 2.

### Match'em

If the sum of the “top” hand for the player matches the sum of the “top” hand for the dealer and the sum of the “back” hand also matches then the player wins and is paid at odds of 5 to 1.

Match'em 9-9 If the sum of the “top” hand for the player matches the sum of the “top” hand for the dealer and the sum of the “back” hand also matches and both hands total 9-9 then the player wins and is paid at odds of 15 to 1.

If the player does not win according to one of the above criteria, they lose their stake.

1. A banker's card game in which:
i) a player plays a first double denomination playing card and a second double denomination playing card from a deck of mutually different cards, with each double denomination playing card having thereon a first playing field with a designated value and a second playing field with a designated value that is independent of the designated value of the first playing field, and the player has a first hand value that is the sum of a) the designated value of the first playing field of the first card and the designated value of the first playing field of the second card and has a second hand value comprised of the sum of a) the designated value of the second playing field of the first card and b) the designated value of the second playing field of the second card;
ii) a banker plays a third double denomination playing card and a fourth double denomination playing card from said deck of mutually different cards, with each double denomination playing card having thereon a first playing field with a designated value and a second playing field with a designated value that is independent of the designated value of the first playing field, and the banker has a third hand value that is the sum of a) the designated value of the first playing field of the third card and b) the designated value of the first playing field of the fourth card and has a fourth hand value that is the sum of a) the designated value of the second playing field of the third card and b) the designated value of the second playing field of the fourth card; and
iii) the player's first hand value is compared against the banker's third hand value and the player's second hand value is compared against the banker's fourth hand value and the rules of the game dictate a win based thereon.

2. A bankers' playing card game as claimed in claim 1, wherein the first playing field of a playing card is at a top end of a front face of the playing card and the second playing field is at a bottom end of the front face of the playing card.

3. A bankers' playing card game as claimed in claim 2, wherein in the game the player is enabled to spin a playing card to dictate which is the top end and which is the bottom end of the playing card to thereby dictate a said hand value.

4. A bankers' playing card game as claimed in claim 3, wherein the playing cards in a player's hand are placed side by side and the denominated values of the playing cards from the player's first hand are read in a row (horizontally) and summed together.

5. A bankers' playing card game as claimed in claim 1, wherein the double denomination playing cards are all drawn from a set or deck that comprises at least 240 mutually different double denomination playing cards.

6. A bankers' playing card game as claimed in claim 5, wherein the set or deck is a symmetrical sub-deck of a deck of 1,378 mutually different double denomination playing cards.

7. A bankers' playing card game as claimed in claim 1, wherein the modulus 10 (or Mod 10) form of arithmetic is used in calculating the first, second, third and fourth hand values.

8. A bankers' playing card game as claimed in claim 1, wherein the player can play a bonus bet only if the playing fields of their cards form a hand that meets qualifying criteria.

9. A bankers' playing card game as claimed in claim 1, wherein the player can select to play for additional winnings by a game step that involves comparing the suit or colour(s) of a player hand to the suit or colour(s) of a banker hand to determine if there is a match.

10. A bankers' playing card game as claimed in claim 8 and further as claimed in claim 9, wherein the player can select to gamble their bonus winnings by the game step that involves comparing the suit or colour(s) of a player hand to the suit or colour(s) of a banker hand to determine if there is a match.

11. A bankers' playing card game as claimed in claim 1 and 2, wherein in the game the banker is enabled to spin a playing card to dictate which is the top end and which is the bottom end of the playing card to thereby dictate a said hand value.

12. A bankers' playing card game as claimed in claim 11, wherein the banker is subject to rules that restrict the orientation in which the banker may play cards.

13. A bankers' playing card game as claimed in claim 12, wherein the banker must play the highest possible third hand value at top ends of the front faces of the banker's cards.

14. A bankers' playing card game as claimed in claim 12, wherein the banker must play at least one of the third hand value and fourth hand value to be a defined minimum numerical value.

15. A bankers' playing card game as claimed in claim 14, wherein the banker must play at least one of the third hand value and fourth hand value to be at least one.
